(19) United States
(12) Patent Application Publication
(10) Pub. No.: US 2024/0335712 A1
(43) Pub. Date: Oct. 10, 2024

(54) GOLF CLUB SHAFT

(71) Applicant: SUMITOMO RUBBER INDUSTRIES, LTD., Kobe-shi (JP)

(72) Inventor: Yoshitomo Uenishi, Kobe-shi (JP)

(73) Assignee: SUMITOMO RUBBER INDUSTRIES, LTD., Kobe-shi (JP)

(21) Appl. No.: 18/606,418

(22) Filed: Mar. 15, 2024

(30) Foreign Application Priority Data
Apr. 7, 2023 (JP) 2023-063073

(51) Int. Cl. A63B 53/10; B32B 3/18; B32B 5/02; B32B 5/26

(52) U.S. Cl. CPC A63B 53/10; B32B 3/18; B32B 5/02; B32B 5/26; A63B 2209/023; B32B 2260/023; B32B 2260/046; B32B 2262/106; B32B 2307/718; B32B 2307/7376

(57) ABSTRACT

A golf club shaft includes a plurality of fiber reinforced resin layers, a tip end, and a butt end. The golf club shaft also includes a plurality of extending portions each having an axial directional length of greater than 25 mm, and a plurality of transition portions each having an axial directional length of less than or equal to 25 mm and each having an outer diameter changing by 0.3 mm or more. Each of the transition portions connects two of the extending portions. The extending portions include at least one intermediate portion connecting two of the transition portions. The number of the transition portions is greater than or equal to 2, and may be greater than or equal to 3. The extending portions may include a tip extending portion and a butt extending portion.

### CROSS REFERENCE TO RELATED APPLICATION

The present application claims priority to Japanese Patent Application No. 2023-063073 filed on Apr. 7, 2023. The entire contents of this Japanese Patent Application are hereby incorporated by reference.

### BACKGROUND

### Technical Field

The present disclosure relates to golf club shafts.

### Description of the Related Art

There has been known a golf club shaft formed of a plurality of fiber reinforced resin layers. One example of such a shaft is referred to as a carbon shaft. Such a shaft usually has a taper shape in which the outer diameter of the shaft decreases continuously toward its tip end.

JPH8-173580A (EP0701843A1) discloses a shaft that is made of carbon fiber composite materials and includes at least three cylindrical sections and at least two tapered sections. In this shaft, each of the tapered sections is interposed between adjacent cylindrical sections.

### SUMMARY

Shafts are expected to have various specifications for meeting demands of various golfers. Shafts with excellent suitability for respective golfers can be produced by increasing the design flexibility of the shafts.

One of the objects of the present disclosure is to provide a golf club shaft excellent in the design flexibility of the shaft.

In one aspect, a golf club shaft includes a plurality of fiber reinforced resin layers, a tip end, and a butt end. The golf club shaft also includes a plurality of extending portions each having an axial directional length of greater than 25 mm, and a plurality of transition portions each having an axial directional length of less than or equal to 25 mm and each having an outer diameter changing by 0.3 mm or more. Each of the transition portions connects two of the extending portions. The extending portions include at least one intermediate portion that connects two of the transition portions.

### BRIEF DESCRIPTION OF THE DRAWINGS

FIG. 1 shows a shaft according to a first embodiment, and also includes an enlarged figure of a part of a cross-sectional view taken along the center line of the shaft;

FIG. 2 shows a shaft according to a second embodiment;

FIG. 3 shows a shaft according to a third embodiment;

FIG. 4 shows a shaft according to a fourth embodiment;

FIG. 5 shows a shaft according to a fifth embodiment;

FIG. 6 is an example of a developed view of a shaft;

FIG. 7 is a developed view of a shaft of Example 1;

FIG. 8 is a graph showing distributions of the outer diameter, inner diameter and wall thickness of the shaft of Example 1;

FIG. 9 is a developed view of a shaft of Example 2; and

FIG. 10 is a graph showing distribution of the outer diameter, inner diameter and wall thickness of the shaft of Example 2.

### DESCRIPTION OF THE PREFERRED EMBODIMENTS

Hereinafter, embodiments will be described in detail with appropriate references to the accompanying drawings.

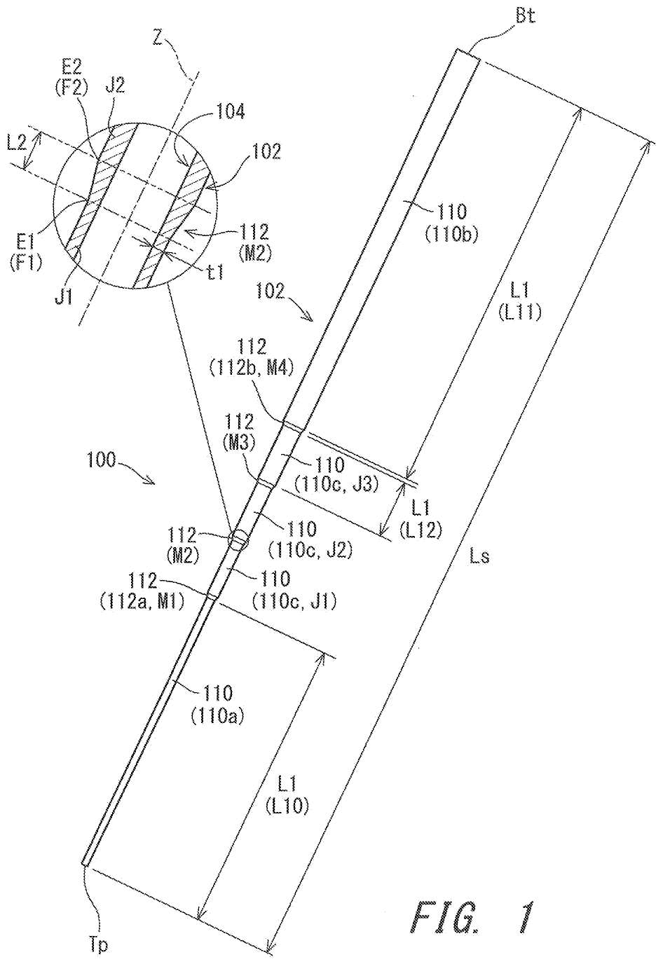

FIG. 1 shows a shaft 100 according to a first embodiment. The shaft 100 includes a tip end Tp and a butt end Bt. The shaft 100 has a center line Z that is a straight line. An enlarged figure in FIG. 1 shows a part of a cross-sectional view taken along the center line Z. The shaft 100 constitutes a tube having a hollow interior. The shaft 100 includes an outer surface 102 and an inner surface 104. The outer surface 102 has a circular shape about the center line Z in a cross-section taken along a plane perpendicular to the center line Z. The inner surface 104 has a circular shape about the center line Z in the cross section taken along the plane perpendicular to the center line Z. The shaft 100 has an outer diameter and an inner diameter. The shaft 100 has a shaft length Ls. The shaft length Ls is measured in an axial direction.

Note that shapes of cross-sectional contour lines of the outer surface 102 and the inner surface 104 in the cross section taken along the plane perpendicular to the center line Z are substantially circles. These shapes, however, may not be a perfect circle due to an error in winding a sheet(s) and/or in forming, for example. In addition, in the cross-sectional contour lines, a step that has a height equal to the thickness of a sheet can be unavoidably generated at an end of winding of the sheet. From these viewpoints, when the cross-sectional contour line of the outer surface 102 in the cross section taken along the plane perpendicular to the center line Z does not have a perfect circular shape, the outer diameter of the shaft 100 is considered as the diameter of a circle that has the same area as the area of a figure formed by the cross-sectional contour line of the outer surface 102. Similarly, when the cross-sectional contour line of the inner surface 104 in the cross section taken along the plane perpendicular to the center line Z does not have a perfect circular shape, the inner diameter of the shaft 100 is considered as the diameter of a circle that has the same area as the area of a figure formed by the cross-sectional contour line of the inner surface 104. A taper ratio and a shaft wall thickness t1 can be calculated based on the outer diameter and the inner diameter.

As shown in the enlarged figure of FIG. 1, the shaft 100 has a wall thickness t1. The wall thickness t1 is measured in a radial direction of the shaft 100. The wall thickness t1 is a distance between the outer surface 102 and the inner surface 104. The wall thickness t1 can be calculated by subtracting the inner diameter from the outer diameter and dividing the difference by 2. The wall thickness t1 is also referred to as a shaft wall thickness.

As described below, the shaft 100 includes a plurality of fiber reinforced resin layers. Boundaries between layers are omitted in the cross-sectional view of FIG. 1.

The shaft 100 has an axial direction, a radial direction, and a circumferential direction. The axial direction is the direction of the center line Z. In the present disclosure, the axial direction of the shaft 100 is also simply referred to as an axial direction. In the present disclosure, the radial direction of the shaft 100 is also simply referred to as a radial direction. In the present disclosure, the circumferential direction of the shaft 100 is also simply referred to as a circumferential direction. In the present disclosure, an inner side in the radial direction is also referred to as an inner layer side. In the present disclosure, an outer side in the radial direction is also referred to as an outer layer side.

The shaft 100 includes a plurality of extending portions 110 each having a length in the axial direction of greater than 25 mm (in the present disclosure, a length in the axial direction is also referred to as an axial directional length). In the present embodiment, the number of the extending portions 110 is five. The closer the position of the extending portion 110 is to the tip end Tp, the smaller the outer diameter of the extending portion 110 is. In other words, the closer the position of the extending portion 110 is to the butt end Bt, the larger the outer diameter of the extending portion 110 is. In addition, each extending portion 110 has a changing outer diameter.

The shaft 100 includes a plurality of transition portions 112 each connecting two of the extending portions 110. As shown in the enlarged cross-sectional figure in FIG. 1, each transition portion 112 is a region between a butt-side end E1 of one extending portion 110 and a tip-side end E2 of another extending portion 110 that is located closest to the one extending portion 110 and positioned on the butt side of the one extending portion 110. In the present embodiment, the number of the transition portions 112 is four.

The extending portions 110 and the transition portions 112 are alternately arranged in the axial direction. Each of the transition portions 112 is interposed between adjacent extending portions 110.

The extending portions 110 include a tip extending portion 110a that extends from the tip end Tp to a transition portion 112a located closest to the tip end Tp, a butt extending portion 110b that extends from the butt end Bt to a transition portion 112b located closest to the butt end Bt, and a plurality of intermediate portions 110c each connecting two of the transition portions 112. Each intermediate portion 110c is a portion located between two of the transition portions 112. The number of the tip extending portion 110a is one, and the number of the butt extending portion 110b is one. The number of the intermediate portions 110c may be one or may be two or more. In the present embodiment, the number of the intermediate portions 110c is three. The plurality of (three) intermediate portions 110c are arranged at equal intervals in the axial direction.

Each extending portion 110 has an axial directional length L1. As described above, in all the extending portions 110, the axial directional length L1 is greater than 25 mm. The tip extending portion 110a has an axial directional length L10. The butt extending portion 110b has an axial directional length L11. Each of the intermediate portions 110c has an axial directional length L12. When there are a plurality of intermediate portions 110c, their axial directional lengths L12 may be the same or may be different from each other. In the present embodiment, there are the plurality of intermediate portions 110c, and their axial directional lengths L12 are the same. For this reason, the plurality of (four) transition portions 112 are arranged at equal intervals in the axial direction. In the present embodiment, the axial directional length L10 is greater than (the maximum value of) the axial directional length(s) L12. In the present embodiment, the axial directional length L11 is greater than (the maximum value of) the axial directional length(s) L12.

Each transition portion 112 has an axial directional length of less than or equal to 25 mm. Each transition portion 112 has an outer diameter changing by 0.3 mm or more. As shown in the enlarged figure of FIG. 1, each transition portion 112 includes a tip-side end F1 and a butt-side end F2. The outer diameter at the tip-side end F1 is smaller than the outer diameter at the butt-side end F2 by 0.3 mm or more. Each transition portion 112 has a taper in which its outer diameter decreases toward the tip end Tp. A taper ratio of the outer surface 102 of each transition portion 112 is greater than or equal to 0.3 mm/25 mm.

The taper ratio [0.3 mm/25 mm] means a rate of change of diameter (outer diameter or inner diameter) in which the diameter changes by 0.3 mm with respect to the axial directional length of 25 mm. For easy understanding, the taper ratio is expressed in the form of adding the unit [mm] to the numerator and the denominator in the present disclosure. The value of the taper ratio [0.3 mm/25 mm] is 0.3/25, that is 0.012.

In the present disclosure, the taper ratio of the outer surface 102 is also referred to as an outer surface taper ratio, and a taper ratio of the inner surface 104 is also referred to as an inner surface taper ratio.

In the present disclosure, a shape in which the outer diameter decreases toward the tip end Tp is referred to as a taper, and a shape in which the outer diameter increases toward the tip end Tp is referred to as a reverse taper. The taper has a taper ratio of a positive value. The reverse taper has a taper ratio of a negative value.

Each extending portion 110 has a substantially constant outer surface taper ratio or has a constant outer diameter. Each extending portion 110 may include both a part having a substantially constant outer surface taper ratio and a part having a constant outer diameter. The term “substantially constant taper ratio” means that the change of the taper ratio is in the range of −0.025 mm/25 mm to +0.025 mm/25 mm. From the viewpoint of allowing the shaft 100 to have a taper in which the shaft 100 as a whole becomes narrower (thinner) toward the tip end Tp, the outer surface taper ratio of each extending portion 110 is preferably a positive value.

Each extending portion 110 has an outer surface taper ratio of less than 0.3 mm/25 mm. The outer surface taper ratios of all the extending portions 110 are smaller than the outer surface taper ratios of all the transition portions 112. The outer surface taper ratios of the extending portions 110 may be the same, or may be different from each other.

The outer surface taper ratio of each intermediate portion 110c is smaller than outer surface taper ratios of all the transition portions 112. The outer surface taper ratio of each intermediate portion 110c is smaller than 0.3 mm/25 mm. The outer surface taper ratios of all the intermediate portions 110c are smaller than the outer surface taper ratios of all the transition portions 112. The outer surface taper ratios of the intermediate portions 110c may be the same, or may be different from each other.

Note that “a taper ratio is smaller than 0.3 mm/25 mm” means that the taper ratio may be zero or may have a negative value. Note that “the taper ratio of a portion is zero” means that the portion has a constant diameter.

The inner surface 104 forms a taper. The inner diameter of the shaft 100 decreases toward the tip end Tp. The inner surface 104 may include a part having a constant inner diameter. The inner surface 104 can be shaped by the outer surface of a mandrel (described below).

The shape of the inner surface 104 is not so changed as to conform to the shapes of the outer surfaces of the transition portions 112. The inner surface 104 does not include a transition portion. The inner surface taper ratio does not change at the tip-side end F1 of at least one transition portion 112. The inner surface taper ratio does not change at the butt-side end F2 of at least one transition portion 112. In the present embodiment, the inner surface taper ratio does not change at the tip-side ends F1 of all of the transition portions 112, and the inner surface taper ratio does not change at the butt-side ends F2 of all of the transition portions 112.

The inner surface taper ratio of each transition portion 112 is smaller than 0.3 mm/25 mm. The inner surface taper ratios of the transition portions 112 may be the same, or may be different from each other. All of the transition portions 112 may have substantially the same inner surface taper ratio. All of the transition portions 112 may have the same inner surface taper ratio.

The inner surface taper ratio of each extending portion 110 is smaller than 0.3 mm/25 mm. The inner surface taper ratios of the extending portions 110 may be the same, or may be different from each other. All of the extending portions 110 may have substantially the same inner surface taper ratio. All of the extending portions 110 may have the same inner surface taper ratio. In the present embodiment, the inner surface taper ratios of all of the transition portions 112 and the inner surface taper ratios of all of the extending portions 110 are the same. In the present embodiment, the inner surface taper ratio over the entire length of the shaft 100 is smaller than 0.3 mm/25 mm.

As shown in the enlarged figure of FIG. 1, each transition portion 112 has a wall thickness t1 decreasing toward the tip end Tp. The rate of change of the wall thickness t1 of each transition portion 112 can be adjusted by the outer surface taper ratio of the transition portion 112.

As discussed above, the shaft 100 includes a first transition portion M1, a second transition portion M2, a third transition portion M3 and a fourth transition portion M4 in descending order of proximity to the tip end Tp. The first transition portion M1 is the transition portion 112a located closest to the tip end Tp. The fourth transition portion M4 is the transition portion 112b located closest to the butt end Bt. The shaft 100 also includes a first intermediate portion J1, a second intermediate portion J2 and a third intermediate portion J3 in descending order of proximity to the tip end Tp. The first intermediate portion J1 is an intermediate portion 110c located closest to the tip end Tp. The third intermediate portion J3 is an intermediate portion 110c located closest to the butt end Bt. The first intermediate portion J1 connects the first transition portion M1 and the second transition portion M2. The second intermediate portion J2 connects the second transition portion M2 and the third transition portion M3. The third intermediate portion J3 connects the third transition portion M3 and the fourth transition portion M4. The first transition portion M1 connects the tip extending portion 110a and the first intermediate portion J1. The second transition portion M2 connects the first intermediate portion J1 and the second intermediate portion J2. The third transition portion M3 connects the second intermediate portion J2 and the third intermediate portion J3. The fourth transition portion M4 connects the third intermediate portion J3 and the butt extending portion 110b.

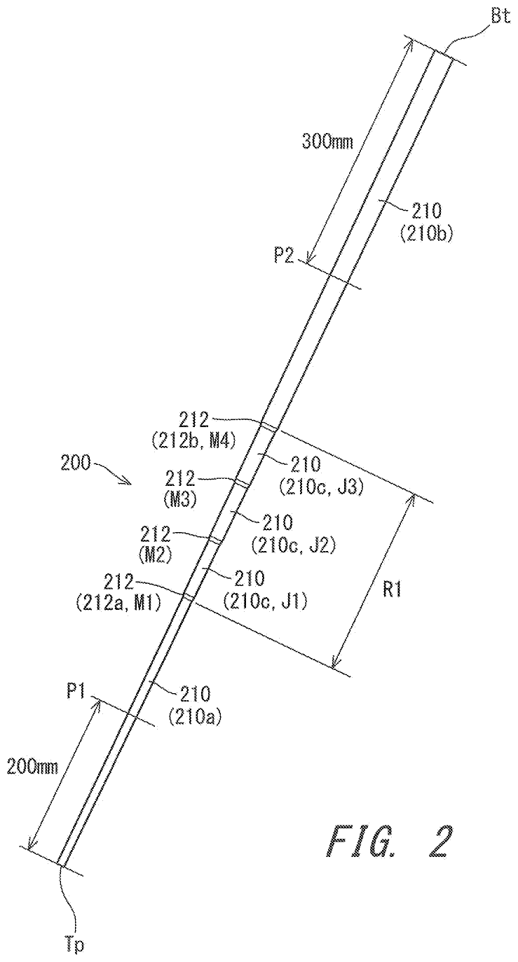

FIG. 2 shows a shaft 200 according to a second embodiment. The shaft 200 includes a tip end Tp and a butt end Bt. The shaft 200 includes a plurality of fiber reinforced resin layers. The shaft 200 includes a plurality of extending portions 210 each having an axial directional length of greater than 25 mm. In the present embodiment, the number of the extending portions 210 is five. The closer the position of the extending portion 210 is to the tip end Tp, the smaller the outer diameter of the extending portion 210 is. In other words, the closer the position of the extending portion 210 is to the butt end Bt, the larger the outer diameter of the extending portion 210 is. In addition, each extending portion 210 has a changing outer diameter.

The shaft 200 includes a plurality of transition portions 212 each connecting two of the extending portions 210. In the present embodiment, the number of the transition portions 212 is four. The extending portions 210 include a tip extending portion 210a that extends from the tip end Tp to a transition portion 212a located closest to the tip end Tp, a butt extending portion 210b that extends from the butt end Bt to a transition portion 212b located closest to the butt end Bt, and an intermediate portion(s) 210c (each) connecting two of the transition portions 212. In the present embodiment, the number of the intermediate portions 210c is three.

As discussed above, as with the shaft 100, the shaft 200 includes a first transition portion M1, a second transition portion M2, a third transition portion M3 and a fourth transition portion M4 in descending order of proximity to the tip end Tp. The shaft 200 also includes a first intermediate portion J1, a second intermediate portion J2 and a third intermediate portion J3 in descending order of proximity to the tip end Tp.

The outer surface taper ratios of the transition portions 212 of the shaft 200 are different from those of the shaft 100. The outer surface taper ratios of the transition portions 212 of the shaft 200 are smaller than those of the shaft 100. This makes the change in the outer diameter of each transition portion 212 of the shaft 200 smaller. As a result, the shaft 100 has a smaller outer diameter of the tip extending portion and a larger outer diameter of the butt extending portion as compared with those of the shaft 200. Except for these configurations, the shaft 200 is the same as the shaft 100.

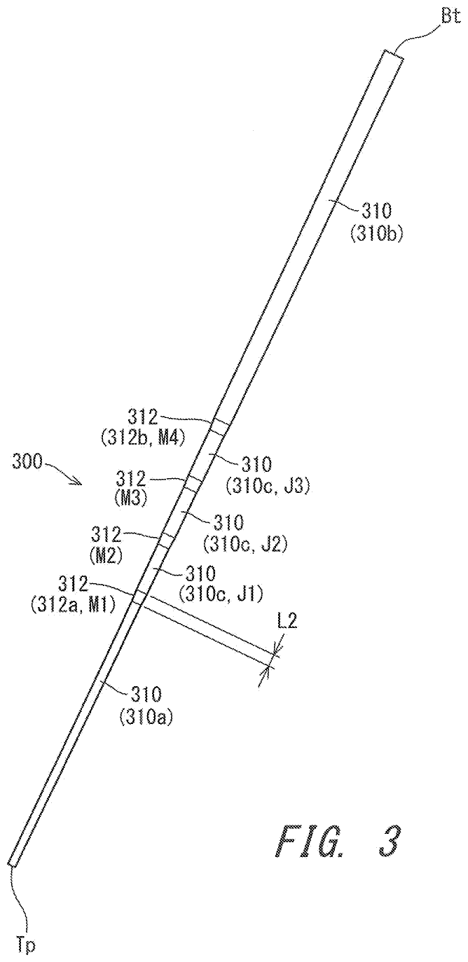

FIG. 3 shows a shaft 300 according to a third embodiment. The shaft 300 includes a tip end Tp and a butt end Bt. The shaft 300 includes a plurality of fiber reinforced resin layers. The shaft 300 includes a plurality of extending portions 310 each having an axial directional length of greater than 25 mm. In the present embodiment, the number of the extending portions 310 is five. The closer the position of the extending portion 310 is to the tip end Tp, the smaller the outer diameter of the extending portion 310 is. In addition, each extending portion 310 has a changing outer diameter.

The shaft 300 includes a plurality of transition portions 312 each connecting two of the extending portions 310. In the present embodiment, the number of the transition portions 312 is four. The extending portions 310 include a tip extending portion 310a that extends from the tip end Tp to a transition portion 312a located closest to the tip end Tp, a butt extending portion 310b that extends from the butt end Bt to a transition portion 312b located closest to the butt end Bt, and a plurality of intermediate portions 310c each connecting two of the transition portions 312. In the present embodiment, the number of the intermediate portions 310c is three.

As discussed above, as with the shaft 100, the shaft 300 includes a first transition portion M1, a second transition portion M2, a third transition portion M3 and a fourth transition portion M4 in descending order of proximity to the tip end Tp. The shaft 300 also includes a first intermediate portion J1, a second intermediate portion J2 and a third intermediate portion J3 in descending order of proximity to the tip end Tp.

The axial directional length L2 of each transition portion 312 of the shaft 300 is different from that of the shaft 100. The axial directional length L2 of each transition portion 312 of the shaft 300 is greater than that of the shaft 100. This makes intervals between the extending portions 310 in the shaft 300 greater. Except for this configuration, the shaft 300 is the same as the shaft 100. As with the above shafts, the axial directional length L2 in the shaft 300 is also less than or equal to 25 mm.

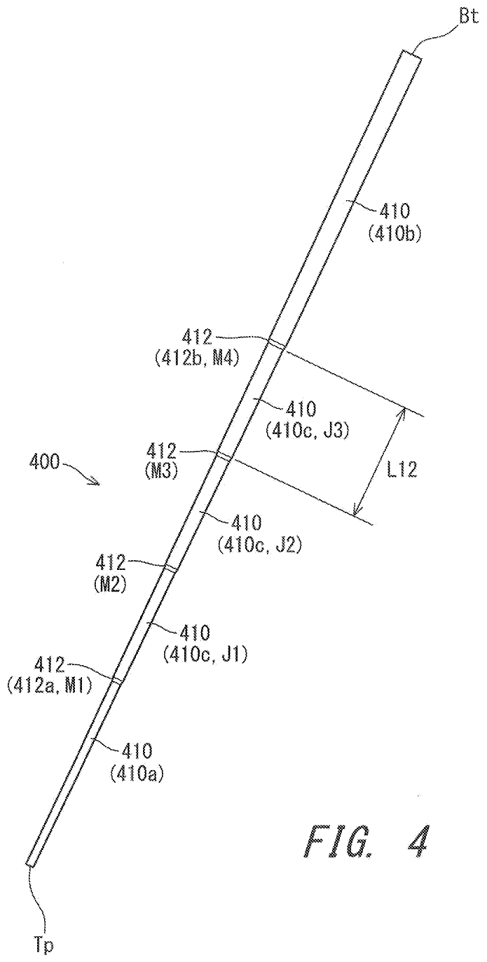

FIG. 4 shows a shaft 400 according to a fourth embodiment. The shaft 400 includes a tip end Tp and a butt end Bt. The shaft 400 includes a plurality of fiber reinforced resin layers. The shaft 400 includes a plurality of extending portions 410 each having an axial directional length of greater than 25 mm. In the present embodiment, the number of the extending portions 410 is five. The closer the position of the extending portion 410 is to the tip end Tp, the smaller the outer diameter of the extending portion 410 is. In addition, each extending portion 410 has a changing outer diameter.

The shaft 400 includes a plurality of transition portions 412 each connecting two of the extending portions 410. In the present embodiment, the number of the transition portions 412 is four. The extending portions 410 include a tip extending portion 410a that extends from the tip end Tp to a transition portion 412a located closest to the tip end Tp, a butt extending portion 410b that extends from the butt end Bt to a transition portion 412b located closest to the butt end Bt, and a plurality of intermediate portions 410c each connecting two of the transition portions 412. In the present embodiment, the number of the intermediate portions 410c is three.

As discussed above, as with the shaft 200, the shaft 400 includes a first transition portion M1, a second transition portion M2, a third transition portion M3 and a fourth transition portion M4 in descending order of proximity to the tip end Tp. The shaft 400 also includes a first intermediate portion J1, a second intermediate portion J2 and a third intermediate portion J3 in descending order of proximity to the tip end Tp.

The axial directional length L12 of each intermediate portion 410c of the shaft 400 is different from that of the shaft 200. The axial directional length L12 of the shaft 400 is greater than that of the shaft 200. This makes intervals between the transition portions 412 in the shaft 400 greater. Except for this configuration, the shaft 400 is the same as the shaft 200.

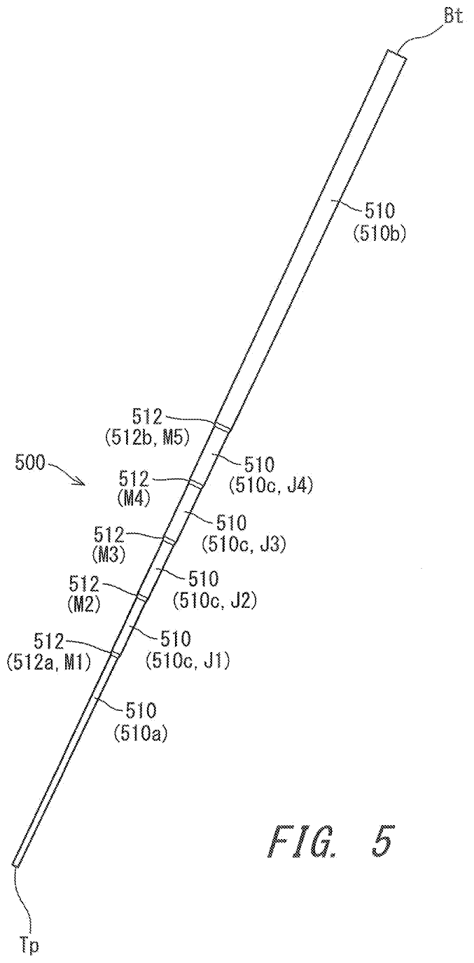

FIG. 5 shows a shaft 500 according to a fifth embodiment. The shaft 500 includes a tip end Tp and a butt end Bt. The shaft 500 includes a plurality of fiber reinforced resin layers. The shaft 500 includes a plurality of extending portions 510 each having an axial directional length of greater than 25 mm. In the present embodiment, the number of the extending portions 510 is six. The closer the position of the extending portion 510 is to the tip end Tp, the smaller the outer diameter of the extending portion 510 is. In addition, each extending portion 510 has a changing outer diameter.

The shaft 500 includes a plurality of transition portions 512 each connecting two of the extending portions 510. In the present embodiment, the number of the transition portions 512 is five. The extending portions 510 include a tip extending portion 510a that extends from the tip end Tp to a transition portion 512a located closest to the tip end Tp, a butt extending portion 510b that extends from the butt end Bt to a transition portion 512b located closest to the butt end Bt, and a plurality of intermediate portions 510c each connecting two of the transition portions 512. In the present embodiment, the number of the intermediate portions 510c is four.

As discussed above, the shaft 500 includes a first transition portion M1, a second transition portion M2, a third transition portion M3, a fourth transition portion M4 and a fifth transition portion M5 in descending order of proximity to the tip end Tp. The shaft 500 also includes a first intermediate portion J1, a second intermediate portion J2, a third intermediate portion J3, and a fourth intermediate portion J4 in descending order of proximity to the tip end Tp.

The number of the transition portions 512 of the shaft 500 is different from that of the shaft 200. This also causes difference between the number of the intermediate portions 510c in the shaft 500 and that of the shaft 200. Except for these configurations, the shaft 500 is the same as the shaft 200.

As described above, each of the shafts explained above is formed by a plurality of fiber reinforced resin layers. Each shaft is formed by winding a plurality of prepreg sheets. In the prepreg sheets, fibers are oriented substantially in one direction. Such a prepreg in which fibers are oriented substantially in one direction is also referred to as a UD prepreg. The term “UD” stands for unidirectional. The prepreg sheets may be made of a prepreg other than UD prepreg. For example, fibers contained in the prepreg sheets may be woven. In the present disclosure, the prepreg sheet(s) is/are also simply referred to as a sheet(s).

Each prepreg sheet contains fibers and a resin. The resin is also referred to as a matrix resin. Carbon fibers, glass fibers, and metallic fibers are exemplified as the fibers. The matrix resin is typically a thermosetting resin.

Examples of the matrix resin in the prepreg sheet include a thermosetting resin and a thermoplastic resin. From the viewpoint of shaft strength, the matrix resin is preferably a thermosetting resin, and more preferably an epoxy resin.

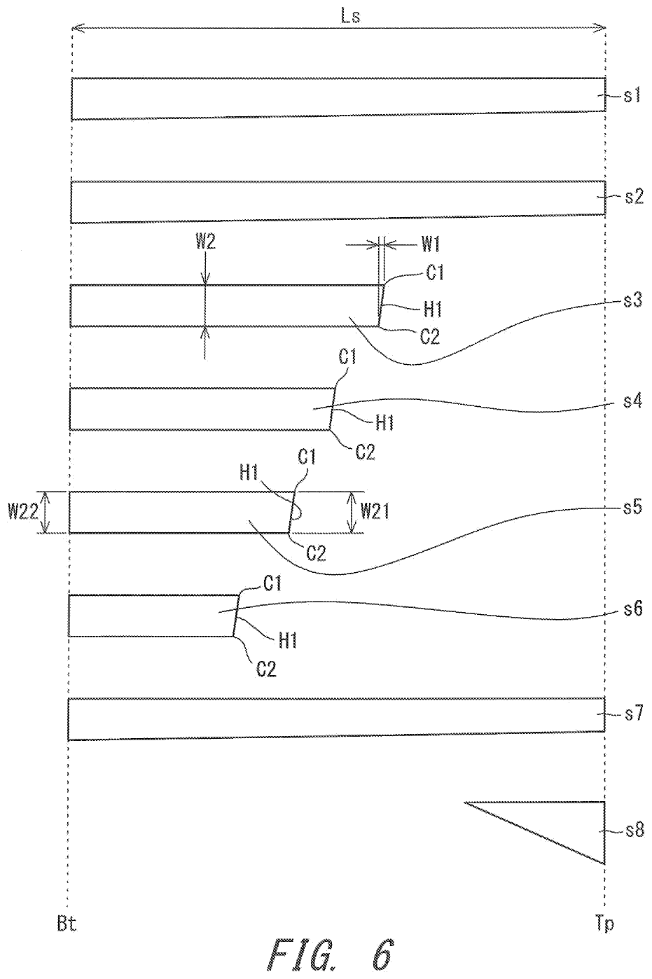

FIG. 6 is an example of a developed view of prepreg sheets constituting a shaft. Four transition portions are formed in the shaft having this laminated configuration. Accordingly, the above-described shafts 100, 200, 300 and 400 can be produced by the laminated configuration of FIG. 6.

FIG. 6 shows the sheets constituting the shaft. The shaft of the present embodiment is constituted by a plurality of sheets. In the present embodiment, the shaft is constituted by eight sheets. That is, the shaft includes a first sheet s1 to an eighth sheet s8. The developed view shows the sheets constituting the shaft in order from the radial inside of the shaft. The sheets are wound in order from the sheet located on the uppermost side in FIG. 6. In FIG. 6, the horizontal direction of the figure coincides with the axial direction. In FIG. 6, the right side of the figure is the tip side of the shaft. In FIG. 6, the left side of the figure is the butt side of the shaft. FIG. 6 shows not only the winding order of the sheets but also the position of each of the sheets in the axial direction. For example, in FIG. 6, an end of the sheet s8 is located at the tip end Tp. A wound sheet constitutes a layer.

The shaft according to the present embodiment includes a straight layer and a bias layer. The straight layer is a layer in which the orientation angle of the fibers is substantially set at 0° with respect to the axial direction (hereinafter, an orientation angle of the fibers is also referred to as a fiber orientation angle). Usually, the fiber orientation may not completely be parallel to the axial direction due to an error in winding, for example. In the straight layer, an absolute angle of the fiber orientation angle with respect to the axial direction is less than or equal to 10°. The absolute angle means an absolute value of an angle (fiber orientation angle) formed between the axial direction and the orientation of fibers. That is, “the absolute angle is less than or equal to 100” means that “the fiber orientation angle is greater than or equal to −10° and less than or equal to +10°”. The bias layer is a layer in which the fiber orientation is substantially inclined with respect to the axial direction. Preferably, bias layers are constituted by a pair of two sheets (herein after referred to as a sheet pair) in which fiber orientation angles of the respective sheets are inclined inversely to each other. Preferably, the sheet pair includes: a layer having a fiber orientation angle of greater than or equal to −60° and less than or equal to −30°; and a layer having a fiber orientation angle of greater than or equal to 30° and less than or equal to 60°. That is, the absolute angle in the bias layers is preferably greater than or equal to 30° and less than or equal to 60°. Generally, the absolute angle of the fiber orientation angle in the bias layers can be substantially set at 45°. However, the fiber orientation angle relative to the shaft axial direction may not be completely set at 45° due to an error in winding, for example. In this case, the absolute angle of the fiber orientation angle can be greater than or equal to 40° and less than or equal to 50°.

The shaft according to the present embodiment may also include a hoop layer. The hoop layer is a layer that is disposed so that the fiber orientation substantially coincides with the circumferential direction of the shaft. Preferably, in the hoop layer, the absolute angle of the fiber orientation angle is substantially set at 90° with respect to the shaft axial direction. However, the fiber orientation angle relative to the axial direction may not be completely set at 90° due to an error in winding, for example. In the hoop layer, the absolute angle of the fiber orientation angle is usually greater than or equal to 80° and less than or equal to 90°.

In the embodiment of FIG. 6, there is no limitation on the fiber orientation angle of each sheet. For example, the sheet s1 and the sheet s2 may be bias layers. For example, the sheet s7 may be a straight layer. For example, the sheet s8 may be a straight layer.

The sheet s3, the sheet s4, the sheet s5 and the sheet s6 are transition portion forming sheets that constitute transition portions. A wound transition portion forming sheet constitutes a transition portion forming layer. The number of the transition portion forming layers is the same as the number of the transition portions. The transition portion forming layers may be straight layers. The transition portion forming layers may be bias layers. The transition portion forming layers may be hoop layers. In the present embodiment, each transition portion forming sheet has a quadrilateral shape.

The shaft according to the present disclosure may include at least one full length layer disposed over an entire length of the shaft in the axial direction, and a plurality of partial layers each being disposed on a part of the shaft in the axial direction. In the embodiment of FIG. 6, sheets constituting full length layers are the sheet s1, the sheet s2 and the sheet s7, and sheets constituting partial layers are the sheet s3, the sheet s4, the sheet s5, the sheet s6 and the sheet s8. The partial layers may include a tip partial layer disposed on the tip side, and a butt partial layer disposed on the butt side. Preferably, a tip-side end of the tip partial layer is positioned at the tip end Tp. Preferably, a butt-side end of the butt partial layer is positioned at the butt end Bt. In the embodiment of FIG. 6, a sheet constituting the tip partial layer is the sheet s8. Sheets constituting butt partial layers are the sheet s3, the sheet s4, the sheet s5 and the sheet s6. All of the transition portion forming layers are the butt partial layers. The butt-side ends of all of the transition portion forming layers coincide with the butt end Bt. The longer the axial directional length of the transition portion forming layer is, the more the transition portion forming layer is disposed on the inner layer side. The more the transition portion to be formed by the transition portion forming layer is located on the tip side, the more the transition portion forming layer is disposed on the inner layer side.

Each of the transition portion forming layers s3, s4, s5 and s6 extends from the butt side of the shaft to an intermediate position of the shaft. The intermediate position of the shaft means a position other than the tip end Tp and the butt end Bt. In the present embodiment, each of the transition portion forming layers s3, s4, s5 and s6 extends from the butt end Bt to an intermediate position of the shaft.

Each of the transition portion forming layers s3, s4, s5 and s6 includes a tip-side edge Hi. Each tip-side edges Hi constitutes a transition portion. In the present embodiment, the tip-side edge Hi in each transition portion forming sheet has a shape of a straight line. The tip-side edge Hi in each transition portion forming sheet may be bent or curved. Each tip-side edge Hi is inclined with respect to the circumferential direction (vertical direction in FIG. 6). Each tip-side edge Hi has a width W1 in the axial direction (hereinafter also referred to as an axial directional width W1). The width W1 is an axial directional distance between a first angle C1 and a second angle C2 of the transition portion forming sheet s3. In each transition portion forming sheet, the edge Hi is a side connecting the first angle C1 and the second angle C2. When a transition portion forming sheet has been wound, its tip-side edge Hi constitutes a helical step. The axial directional width W1 of the tip-side edge Hi is the axial directional length of the helix (helical step) formed by the tip-side edge Hi. The axial directional width W1 is equal to the axial directional length L2 of the transition portion. The axial directional length L2 can be adjusted to less than or equal to 25 mm by setting the axial directional width W1 to less than or equal to 25 mm.

The transition portion forming layer s3 which is the first layer counted from the inner layer side among the transition portion forming layers s3, s4, s5 and s6 constitutes the first transition portion M1. That is, among the transition portion forming layers s3, s4, s5 and s6, the transition portion forming layer s3 which is the first layer counted from the inner layer side constitutes the transition portion M1 located closest to the tip end Tp. Among the transition portion forming layers s3, s4, s5 and s6, the transition portion forming layer s4 which is the second layer counted from the inner layer side constitutes the second transition portion M2. Among the transition portion forming layers s3, s4, s5 and s6, the transition portion forming layer s5 which is the third layer counted from the inner layer side constitutes the third transition portion M3. Among the transition portion forming layers s3, s4, s5 and s6, the transition portion forming layer s6 which is the fourth layer counted from the inner layer side constitutes the fourth transition portion M4. That is, among the transition portion forming layers s3, s4, s5 and s6, the transition portion forming layer s6 which is the first layer counted from the outer layer side constitutes the transition portion M4 located closest to the butt end Bt. As to the transition portion forming layers, the longer the axial directional length of the transition portion forming layer is, the more the transition portion forming layer is disposed on the inner layer side.

The tip-side edge of each transition portion forming layer may be exposed to the outside of the shaft, or may be covered by another layer. In the embodiment of FIG. 6, tip-side edges Hi are covered by the layer s7. The shape of each transition portion depends on the shape of its tip-side edge Hi. Accordingly, the transition portions are constituted by the transition portion forming layers s3, s4, s5 and s6.

The number of the transition portion forming layers (transition portion forming sheets) is the same as the number of the transition portions. For example, when the number of the transition portions is five as in the shaft 500 (FIG. 5), the number of the transition portion forming layers (transition portion forming sheets) can also be five.

The outline of manufacturing processes of the shaft of the embodiment of FIG. 6 is as follows.

### [Outline of Manufacturing Processes of Shaft]

### (1) Cutting Process

Prepreg sheets are cut into respective desired shapes in the cutting process. Each of the sheets shown in FIG. 6 is cut out in this process.

The cutting may be performed by a cutting machine or may be manually performed. In the manual case, a cutter knife is used, for example.

### (2) Sticking Process

In the sticking process, a plurality of sheets are stuck together, as necessary. Sheets constituting bias layers are stuck together. When it is difficult to wind a hoop sheet solely, the hoop sheet is stuck on another sheet. In the sticking process, heating and/or pressing may be carried out.

### (3) Winding Process

A mandrel is prepared in the winding process. A typical mandrel is made of a metal. A mold release agent is applied to the mandrel. Furthermore, a resin having tackiness is applied to the mandrel. This resin is also referred to as a tacking resin. The cut sheets are wound around the mandrel. The tacking resin facilitates the application of the end part (end part of the beginning of winding) of a sheet to the mandrel.

Sheets are wound about the mandrel. A wound object made by winding the sheets around the outside of the mandrel is obtained in the winding process. The winding may be manually performed or may be performed by a machine. The machine is referred to as a rolling machine.

### (4) Tape Wrapping Process

A tape is wrapped around the outer circumferential surface of the wound object in the tape wrapping process. The tape is also referred to as a wrapping tape. The wrapping tape is helically wrapped while tension is applied to the tape so that there is no gap between adjacent windings. The wrapping tape applies pressure to the wound object.

### (5) Curing Process

In the curing process, the wound object after being subjected to the tape wrapping is heated. The heating cures the matrix resin. In the curing process, the matrix resin fluidizes temporarily. The fluidization of the matrix resin can discharge air from between the sheets or in each sheet. The fastening force of the wrapping tape accelerates the discharge of the air.

### (6) Process of Extracting Mandrel and Process of Removing Wrapping Tape

The process of extracting the mandrel and the process of removing the wrapping tape are performed after the curing process. The process of removing the wrapping tape is preferably performed after the process of extracting the mandrel. As a result, a cured laminate can be obtained.

### (7) Process of Cutting Off Both Ends

Both end portions of the cured laminate are cut off in the process. The cutting off flattens the end face of the tip end Tp and the end face of the butt end Bt.

### (8) Polishing Process

The surface of the cured laminate is polished in the process. Spiral unevenness is present on the surface of the cured laminate as the trace of the wrapping tape. The polishing can remove the unevenness to smooth the surface of the cured laminate.

### (9) Coating Process

The cured laminate after the polishing process is subjected to coating, as necessary.

As described above, a mandrel is used for manufacturing a shaft. The mandrel forms the shape of the inner surface of the shaft. The shape of the mandrel conforms to the shape of the inner surface of the shaft. As shown in the enlarged figure of FIG. 1, the shape of the mandrel is not so changed as to conform to the shapes of the transition portions 112. That is, a transition portion is not formed on the mandrel. The transition portions 112 are formed by change of the wall thickness t1 of the shaft.

The shafts described above exhibit the following advantageous effects.

The shaft has a flexural rigidity (hereinafter abbreviated as EI) and a torsional rigidity (hereinafter abbreviated as GJ) at each position in the axial direction. That is, the shaft has an EI distribution and a GJ distribution. EI and/or GJ can be steeply changed by changing the outer diameter of the shaft. In each transition portion, the outer diameter of the shaft is steeply changed within a short distance. EI and/or GJ can be greatly changed by providing the plurality of transition portions. The transition portions can enhance the design flexibility of the shaft.

The elastic modulus of fibers, orientation of fibers, fiber content, the number of plies, thickness, axial directional length, position in the axial direction and the like can be determined for each of the fiber reinforced resin layers. For this reason, a shaft including fiber reinforced resin layers is excellent in design flexibility. Further providing the transition portions in this shaft causes the synergistic effect of the fiber reinforced resin layers and the transition portions, which can further enhance the design flexibility of the shaft.

The presence of the transition portions allows the designer to design various types of shafts. For example, the outer diameter of a portion located close to the butt end Bt of the shaft can be larger with the transition portions, thereby enhancing EI and/or GJ of this portion. By increasing EI and/or GJ of a portion to be gripped and its vicinity (hereinafter collectively referred to as a grip area), the grip area becomes less likely to deform by a force transmitted from golfer's hands, which can provide a shaft excellent in operability. For example, the transition portions can allow the outer diameter of a part of the shaft to be smaller so that this part easily bends, which can change the behavior of the shaft during a swing.

The transition portions also create a visual impact. The transition portions can be viewable from the outside of the shaft. The transition portions make the change of the outer diameter of the shaft viewable. The presence of the transition portions allows golfers to easily understand properties of the shaft. For example, golfers can recognize that a portion extending from the butt end Bt to a transition portion located closest to the butt end Bt has a large diameter. In this case, golfers can recognize that the butt portion (grip area) of the shaft is less likely to bend or less likely to twist.

As shown in the enlarged figure of FIG. 1, the shaft wall thickness t1 of each transition portion 112 decreases toward the tip end Tp. In other words, the shaft wall thickness t1 of each transition portion 112 increases toward the butt end Bt. In each transition portion 112, the smaller its outer diameter is, the smaller the shaft wall thickness t1 is. The synergistic effect of the outer diameter and wall thickness brings about a greater change of EI and/or GJ than the change of EI and/or GJ brought only by the outer diameter.

As shown in the enlarged figure of FIG. 1, the shaft wall thickness t1 of the first intermediate portion J1 is smaller than the shaft wall thickness t1 of the second intermediate portion J2. Each of the first intermediate portion J1 and the second intermediate portion J2 may have a changing shaft wall thickness t1. In this case, the maximum value of the wall thickness t1 of the first intermediate portion J1 is smaller than the minimum value of the wall thickness t1 of the second intermediate portion J2. Similarly, the shaft wall thickness t1 of the second intermediate portion J2 is smaller than the shaft wall thickness t1 of the third intermediate portion J3. In comparison among the intermediate portions, the closer the position of the intermediate portion is to the tip end Tp, the smaller the wall thickness t1 of the intermediate portion is.

The outer diameter of the first intermediate portion J1 is smaller than the outer diameter of the second intermediate portion J2. Each of the first intermediate portion J1 and the second intermediate portion J2 may have a changing outer diameter. In this case, the maximum value of the outer diameter of the first intermediate portion J1 is smaller than the minimum value of the outer diameter of the second intermediate portion J2. Similarly, the outer diameter of the second intermediate portion J2 is smaller the outer diameter of the third intermediate portion J3. In comparison among the intermediate portions, the closer the position of the intermediate portion is to the tip end Tp, the smaller the outer diameter of the intermediate portion is.

As described above, the intermediate portions have their respective outer diameters different from each other and their respective shaft wall thicknesses t1 different from each other, which can further increase the design flexibility of the shaft. As in the above-described embodiment, when the smaller the outer diameter of the intermediate portion is, the smaller the shaft wall thickness t1 of the intermediate portion is, then the synergistic effect of the outer diameter and the wall thickness can cause a great change of EI and GJ.

The number of the transition portions, the length of each transition portion and the position of each transition portion can be determined freely. The taper ratio of each transition portion can also be determined freely. This can increase the design flexibility of the shaft.

From the viewpoint of the design flexibility of the shaft, the number of the transition portions is preferably greater than or equal to 2, more preferably greater than or equal to 3, and still more preferably greater than or equal to 4. When the transition portions are formed by the transition portion forming layers, the excessively large number of the transition portions can result in the excessively large number of the transition portion forming layers. In this case, the number of plies of the transition portion forming layers can be excessively large on the butt side of the shaft. From this viewpoint, the number of the transition portions is preferably less than or equal to 12, more preferably less than or equal to 11, and still more preferably less than or equal to 10.

There is no limitation on positions of the transition portions. As shown in FIG. 2, the shaft 200 has a first position P1 spaced 200 mm apart from the tip end Tp in the axial direction, and a second position P2 spaced 300 mm apart from the butt end Bt in the axial direction. All of the transition portions may be arranged in a region extending from the position P1 to the position P2. When no transition portion is disposed in a region extending from the tip end Tp to the first position P1, stress caused by striking a golf ball is prevented from concentrating on a transition portion, which can improve the strength of the shaft. When no transition portion is disposed in a region extending from the butt end Bt to the second position P2, a grip can be easily attached to the shaft.

By changing the position of each transition portion, the length and the position of each intermediate portion can also be changed. This can increase the design flexibility of the shaft. From the viewpoint of the design flexibility of the shaft, the number of the intermediate portions is preferably greater than or equal to 1, more preferably greater than or equal to 2, and still more preferably greater than or equal to 3. When the transition portions are formed by the transition portion forming layers, the excessively large number of the transition portions can result in the excessively large number of the transition portion forming layers. In this case, the number of plies of the transition portion forming layers can be excessively large on the butt side of the shaft. From this viewpoint, the number of the intermediate portions is preferably less than or equal to 11, more preferably less than or equal to 10, and still more preferably less than or equal to 9. When the number of the transition portions is denoted by n, the number of the intermediate portions can be (n−1). When the number of the transition portions is denoted by n, the number of the extending portions can be (n+1). The number “n” is an integer of greater than or equal to 2.

When the transition portions are formed by the transition portion forming layers, the number of the transition portions can be set by adjusting the number of the transition portion forming sheets. In this case, the positions of the transition portions can also be set by adjusting the lengths and positions of the transition portion forming sheets. The axial directional length L2 of each transition portion can also be set by adjusting the axial directional width W1 of the tip-side edge Hi. Accordingly, a shaft having the transition portions can be easily designed and produced.

From the viewpoint of increasing the outer surface taper ratio of each transition portion, the axial directional width W1 of the tip-side edge Hi is preferably less than or equal to 25 mm, more preferably less than or equal to 20 mm, and still more preferably less than or equal to 15 mm. Also from the viewpoint of visual impact, the axial directional width W1 is preferably small. The axial directional width W1 of the tip-side edge Hi may be 0 mm. In this case, the axial directional length L2 of the transition portion is 0 mm, which can make the transition portion a step with no taper. Thus, each transition portion does not have to form a taper. From the viewpoint of having tapered transition portions, the axial directional width W1 can be greater than or equal to 1 mm, further can be greater than or equal to 2 mm, and still further can be greater than or equal to 3 mm.

A transition portion cover layer may be provided in the shaft as shown with the transition portion cover layer s7 in the embodiment of FIG. 6. In this case, a (slight) axial directional length L2 can be generated by the cover layer s7 even when the axial directional width W1 is 0 mm. This allows each transition portion to have a small axial directional length L2 and a large outer surface taper ratio.

As described above, each transition portion has an axial directional length of less than or equal to 25 mm and has an outer diameter changing by 0.3 mm or more. An increase in the outer surface taper ratio of each transition portion can increase the amount of change of EI and/or GJ. The increase of the outer surface taper ratio of each transition portion can also enhance the visual impact of the transition portion. From these viewpoints, it is preferable that each transition portion has an axial directional length of less than or equal to 20 mm and has an outer diameter changing by 0.3 mm or more, and it is more preferable that each transition portion has an axial directional length of less than or equal to 15 mm and has an outer diameter changing by 0.3 mm or more. The outer surface taper ratio of each transition portion is preferably greater than or equal to 0.3 mm/25 mm, more preferably greater than or equal to 0.3 mm/20 mm, and still more preferably greater than or equal to 0.3 mm/15 mm. The axial directional length L2 of each transition portion is preferably less than or equal to 25 mm, more preferably less than or equal to 15 mm, and still more preferably less than or equal to 10 mm. As described above, the axial directional length L2 may be 0 mm. From the viewpoint of having tapered transition portions, the axial directional length L2 can be greater than or equal to 1 mm, further can be greater than or equal to 2 mm, and still further can be greater than or equal to 3 mm.

From the viewpoints of increasing the amount of change of EI and/or GJ and enhancing the visual impact of each transition portion, the amount of change of the outer diameter of each transition portion is preferably greater than or equal to 0.3 mm, more preferably greater than or equal to 0.4 mm, and still more preferably greater than or equal to 0.5 mm. An excessively large amount of change of the outer diameter of each transition portion can cause an excessively large weight of the transition portion forming layers. From this viewpoint, the amount of change of the outer diameter of each transition portion can be less than or equal to 1.2 mm, further can be less than or equal to 1.1 mm, and still further can be less than or equal to 1.0 mm.

The fiber reinforced resin layers preferably include at least one full length layer disposed over an entire length of the shaft in the axial direction, and partial layers each being disposed on a part of the shaft in the axial direction. The embodiment of FIG. 6 includes full length layers s1, s2 and s7, and partial layers s3, s4, s5, s6 and s8. The partial layers include the transition portion forming layers s3, s4, s5 and s6 the number of which is equal to the number of the transition portions. Each transition portion forming layer extends from the butt side of the shaft to an intermediate position of the shaft, and forms a transition portion by its tip-side edge Hi. In the above embodiments, each transition portion forming layer extends from the butt end Bt to an intermediate position of the shaft, and forms a transition portion by its tip-side edge Hi. In this case, the position of each transition portion can be set by the axial directional length of its transition portion forming layer. The axial directional length L2 of each transition portion can also be set by the axial directional width W1 of the tip-side edge Hi of its transition portion forming layer. The amount of change of the outer diameter of each transition portion can also be set by the wall thickness of its transition portion forming layer.

There is no limitation on the fiber orientation angle of each transition portion forming layer. The transition portion forming layers may be straight layers, may be bias layers, or may be hoop layers. The transition portion forming layers may include two or more types of layers selected from a group consisting of a straight layer, a bias layer, and a hoop layer. The selectability of the fiber orientation angle for each transition portion forming layer can increase the design flexibility of the shaft.

The position of each transition portion and the position of the center of gravity of the shaft can be adjusted by adjusting an axial directional length and/or thickness of each transition portion forming layer, which can increase the design flexibility of the shaft.

As shown in FIG. 6, the transition portion forming sheets s3, s4, s5 and s6 each have a width W2 in the circumferential direction (hereinafter, a width in the circumferential direction is also referred to as a circumferential directional width). The circumferential directional width W2 can be set at each position in the axial direction. The number of plies (number of windings) of each transition portion forming layer at each position in the axial direction can be adjusted by adjusting the circumferential directional width W2. For example, in the embodiment of FIG. 6, each transition portion forming sheet has a constant circumferential directional width W2. In this case, since the mandrel has a taper, the number of plies of each transition portion forming layer increases toward the tip end Tp. Accordingly, the wall thickness t1 of each intermediate portion can increase toward the tip end Tp. By adjusting the circumferential directional width W2, the wall thickness t1 of each intermediate portion, change of the wall thickness t1 of each intermediate portion, the outer surface taper ratio of each intermediate portion, and the like can be adjusted. An adjustment of the circumferential directional width W2 can allow the outer surface of an intermediate portion to have a reverse taper, or can allow an intermediate portion to have a constant outer diameter. Thus, the use of the transition portion forming layers can enhance the design flexibility of the shaft.

At least one of the transition portion forming layers can be a bias layer. All of the transition portion forming layers may be bias layers. The at least one bias layer included in the transition portion forming layers can bring about a greater change in the torsional rigidity GJ than the change of GJ brought only by the change of the outer diameter of the shaft. When at least one of the transition portion forming layers is a bias layer, the shaft can have the following specifications, for example. This configuration allows the butt portion (grip area) of the shaft to have a large GJ to make this area less likely to twist thereby improving operational feeling, and allows a region to be located close to a golf club head to have a small GJ to make this region easy to twist thereby making the opening/closing behavior of the golf club head gentle.

At least one of the transition portion forming layers can be a straight layer. All of the transition portion forming layers may be straight layers. The at least one straight layer included in the transition portion forming layers can bring about a greater change in the flexural rigidity EI than the change of EI brought only by the change of the outer diameter of the shaft. This configuration, for example, allows the butt portion of the shaft to have a great EI and allows a region to be located close to the golf club head to have a small EI. This shaft can make the region to be close to the golf club head easy to bend and can accelerate the head speed.

The transition portion cover layer covering at least one transition portion may be present, or does not have to be present. In the embodiment of FIG. 6, the transition portion cover layer s7 covering all of the transition portions is provided. The transition portion cover layer s7 is a full length layer. The transition portion cover layer s7 is disposed on the outer layer side with respect to the transition portion forming layer s6 which is the first layer counted from the outer layer side among the transition portion forming layers. As shown in FIG. 2, the shaft 200 includes a transition portion locational region R1. The transition portion locational region R1 is a region that extends from the transition portion M1 disposed closest to the tip end Tp to the transition portion M4 disposed closest to the butt end Bt. In the transition portion locational region R1, the transition portion cover layer s7 constitutes the outermost layer of the shaft 200. The number of plies of the transition portion cover layer s7 is only one. The basis weight (weight per unit area) of the transition portion cover layer s7 is less than or equal to 170 g/m². There is no partial layer that covers at least one transition portion. The thickness of the transition portion cover layer s7 is less than or equal to 0.11 mm. An excessively large basis weight of the transition portion cover layer can cause deterioration of viewability of the transition portions. In the embodiment of FIG. 6, the transition portions are viewable even through the transition portion cover layer s7 is provided. From the viewpoint of viewability of the transition portions, the basis weight of the transition portion cover layer is preferably less than or equal to 170 g/m², more preferably less than or equal to 169 g/m², and still more preferably less than or equal to 168 g/m². The smaller the basis weight of the transition portion cover layer is, the higher the viewability of the transition portions is. Considering the amount of material removed by polishing in the polishing process, the basis weight of the transition portion cover layer can be greater than or equal to 120 g/m², further can be greater than or equal to 121 g/m², and still further can be greater than or equal to 122 g/m². From the viewpoint of viewability of the transition portions, the thickness of the transition portion cover layer is preferably less than or equal to 0.11 mm, more preferably less than or equal to 0.109 mm, and still more preferably less than or equal to 0.108 mm. The smaller the thickness of the transition portion cover layer is, the higher the viewability of the transition portions is. Considering the amount of material removed by polishing in the polishing process, the thickness of the transition portion cover layer can be greater than or equal to 0.075 mm, further can be greater than or equal to 0.076 mm, and still further can be greater than or equal to 0.077 mm.

The embodiment of FIG. 6 does not include a partial layer that is the transition portion cover layer. If at least one of the transition portions is covered by a partial layer, the change of the outer diameter caused by the transition portions is not emphasized due to the change of the outer diameter caused by the partial layer. This can decrease the advantageous effects caused by physical properties of the transition portions and the visual impact of the transition portions.

As described above, the shaft can be subjected to coating. The coating can increase the glossiness of the surface of the shaft, for example. A high glossiness accentuates the transition portions to enhance the visual impact of the transition portions. From this viewpoint, the specular gloss of the outer surface of the transition portions is preferably greater than or equal to 50%, more preferably greater than or equal to 60%, still more preferably greater than or equal to 70%, and yet more preferably greater than or equal to 80%. The specular gloss has a limit, and can be less than or equal to 130%, further can be less than or equal to 120%, and still further can be less than or equal to 110%. The specular gloss is measured in accordance with JIS Z8741-1997 “method of measurement for specular gloss” at an incidence angle of 60° and a receptor angle of 60°. The gloss meter “VG 7000” manufactured by Nippon Denshoku Industries Co., Ltd. is used for measuring the specular gloss.

In the above-described embodiments, all of the transition portions and all of the intermediate portions each have a tapered outer surface. In the transition portion locational region R1, the outer diameter of the shaft monotonously decreases toward the tip end Tp. In the shafts of the above-described embodiments, their outer surfaces do not include a portion having a reverse taper. The shafts may include a portion having a constant outer diameter. Each of the shaft of Example 1 and the shaft of Example 2 described below includes a portion having an outer diameter decreasing toward the tip end Tp and a portion having a constant outer diameter. The portion having a constant outer diameter is provided as the butt extending portion.

As shown in the embodiment of FIG. 6, the transition portion forming layers s3, s4, s5 and s6 each have a circumferential directional width W21 at their respective tip-side ends, and a circumferential directional width W22 at their respective butt-side ends. The circumferential directional width W21 is a distance between the first angle C1 and the second angle C2 in the circumferential direction. In other words, the circumferential directional width W21 is the circumferential directional width of the tip-side edge Hi. The circumferential directional width W21 can be greater than or equal to the circumferential directional width W22. That is, the circumferential directional width W21 can be equal to the circumferential directional width W22, or can be greater than the circumferential directional width W22. This configuration increases the number of plies of the transition portion forming layer at the tip-side edge Hi, which can increase the amount of change of the outer diameter in the transition portion.

### EXAMPLES

### Example 1

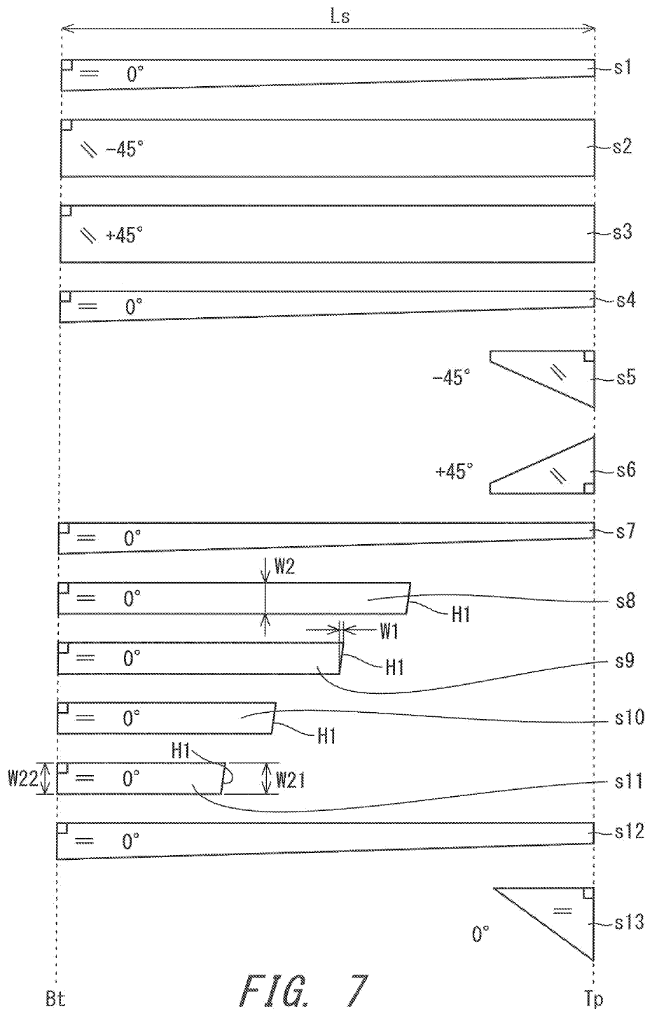

FIG. 7 is a developed view of the shaft of Example 1. This shaft includes a first layer s1 to a thirteenth layer s13 in order from the inner layer side. These layers are carbon fiber reinforced layers. The layers include the full length straight layers s1, s4, s7 and s12, the full length bias layers s2 and s3, the tip partial layers s5 and s6, and the tip partial layer s13. The tip partial layers s5 and s6 are bias layers. The tip partial layer s13 is a straight layer. The shaft also includes the transition portion forming layers s8, s9, s10 and s11 each extending from the butt end Bt to an intermediate position of the shaft. As to the transition portion forming layers s8, s9, s10 and s11, the more the transition portion forming layer is located on the inner layer side, the longer the axial directional length of the transition portion forming layer is. All of the transition portion forming layers s8, s9, s10 and s11 are butt partial layers. All of the transition portion forming layers s8, s9, s10 and s11 are straight layers. The number of plies of each of the transition portion forming layers s8, s9, s10 and s11 increases toward the tip end Tp. The transition portion cover layer s12 is a full length layer and straight layer. A shaft of Example 1 having a configuration of sheets as shown in the developed view of FIG. 7 was obtained by above-described manufacturing processes. The four transition portion forming layers were used to obtain the shaft having four transition portions and three intermediate portions as shown in FIG. 2.

In this shaft, the number of the transition portion forming layers was adjusted, whereby the number of the transition portions was set. The positions of the transition portions were also successfully adjusted by adjusting the axial directional length of each transition portion forming layer. In Example 1, all of the transition portions were arranged at equal intervals in the axial direction. The amount of change of the outer diameter of each transition portion was also successfully adjusted by adjusting the thickness of each transition portion forming layer and its number of plies at its tip-side edge Hi. The adjustment of the axial directional length L2 of each transition portion was also achieved by adjusting the axial directional width W1 of the tip-side edge Hi. As to the transition portion forming layers, the more the transition portion to be formed by the transition portion forming layer was located on the tip side, the more the transition portion forming layer was disposed on the inner layer side. This prevented each transition portion from being covered by a transition portion forming layer that forms another transition portion. The number of plies of the transition portion cover layer s12 was only 1. The transition portion cover layer s12 had a basis weight of 170 g/m². In this shaft, all of the transition portions ware clearly viewable.

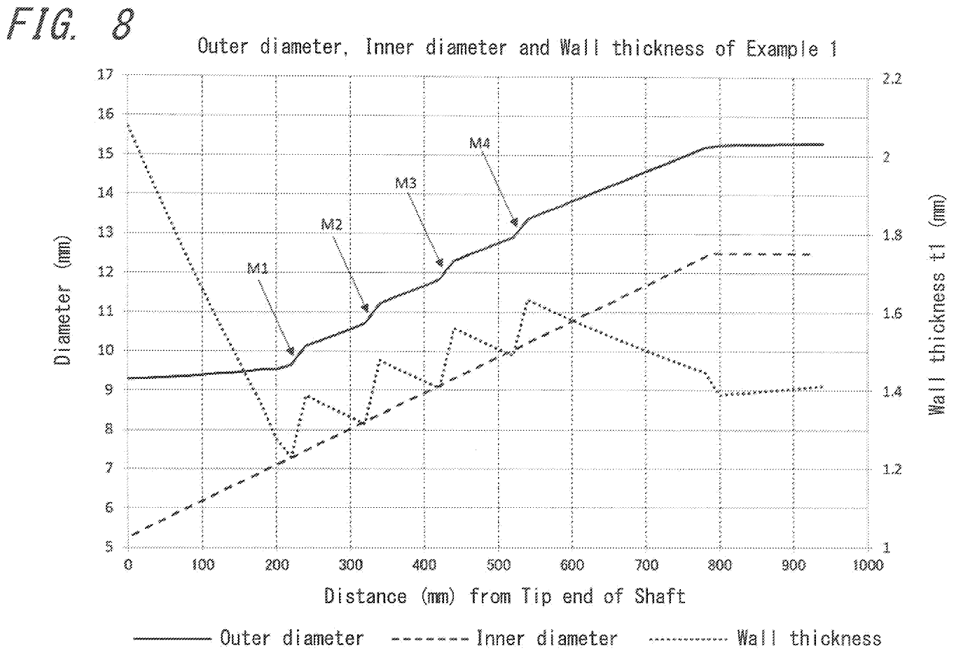

FIG. 8 is a graph showing the outer diameter, inner diameter, and shaft wall thickness t1 of the shaft of Example 1. In this graph, the outer diameter and the inner diameter were plotted against the left-hand scale, and the wall thickness t1 was plotted against the right-hand scale. The horizontal axis of this graph represents distance from the tip end Tp. The outer diameter is indicated by a solid line, the inner diameter is indicated by a dashed line, and the shaft wall thickness t1 is indicated by a dotted line. In the graph, the rate of change of the outer diameter becomes sharp at four positions, and these four positions correspond to the transition portions. The first transition portion is shown as M1, the second transition portion is shown as M2, the third transition portion is shown as M3, and the fourth transition portion is shown as M4.

In Example 1, the amount of change of the outer diameter of each transition portion was 0.5 mm. The axial directional lengths L2 of the transition portions were the same. The axial directional length L2 of each transition portion was 20 mm. The axial directional lengths L12 of the intermediate portions were the same. The axial directional length L12 of each intermediate portion was 80 mm. The transition portions were arranged at equal intervals in the axial direction. All of the transition portions were disposed in a region that extends from the first position P1 to the second position P2 (see FIG. 2).

As shown by the dashed line, the inner surface taper ratio was constant in the transition portion locational region R1 (see FIG. 2). The inner surface taper ratio was smaller than 0.3 mm/25 mm in the transition portion locational region R1. This inner surface was shaped by a mandrel.

As shown by the solid line and the dashed line, all of the transition portions each had an outer surface taper and an inner surface taper. All of the intermediate portions also each had an outer surface taper and an inner surface taper. These shapes were successfully adjusted by adjusting the shape of the mandrel and the shape of each transition portion forming sheet.

The position of each transition portion and the length of each intermediate portion were set by adjusting the axial directional length of each transition portion forming layer. The axial directional length L2 of each transition portion was set by adjusting the length and angle of the tip-side edge Hi of each transition portion forming layer. The amount of change of the outer diameter of each transition portion was set by adjusting the thickness of each transition portion forming layer and the number of plies of each transition portion forming layer at the tip-side edge Hi.

As shown by the dotted line, the shaft wall thickness t1 of each transition portion decreased toward the tip end Tp. In other words, the shaft wall thickness t1 of each transition portion increased toward the butt end Bt. Each transition portion had not only the outer surface taper but also a shaft wall thickness t1 increasing toward the butt end Bt. Each transition portion having this configuration brought about a greater change in EI and GJ than the change of EI and GJ caused only by the change of the outer diameter. The shaft wall thickness t1 of each intermediate portion increased toward the tip end Tp. In each intermediate portion, its outer diameter decreased toward the tip end Tp and its shaft wall thickness t1 increased toward the tip end Tp. This configuration was achieved by increasing the number of plies of each transition portion forming sheet toward the tip end Tp. In each intermediate portion, the change of physical properties (EI, GJ) was successfully suppressed as compared with the change of the physical properties caused only by the change of the outer diameter. As a result, the physical properties were changed intensively in the transition portions.

### Example 2

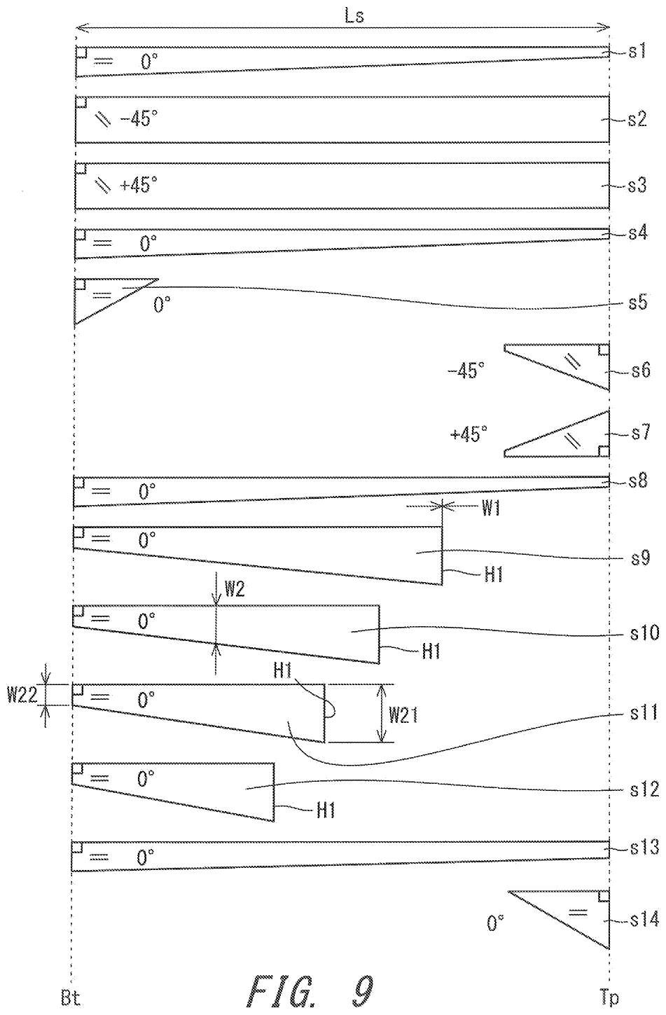

FIG. 9 is a developed view of the shaft of Example 2. This shaft includes a first layer s1 to a fourteenth layer s14 in order from the inner layer side. These layers include the full length straight layers s1, s4, s8 and s13, the full length bias layers s2 and s3, the butt partial layer s5, the tip partial layers s6 and s7, and the tip partial layer s14. The butt partial layer s5 is a straight layer. The tip partial layers s6 and s7 are bias layers. The tip partial layer s14 is a straight layer. The shaft also includes the transition portion forming layers s9, s10, s11 and s12 each extending from the butt end Bt to an intermediate position of the shaft. As to the transition portion forming layers s9, s10, s11 and s12, the more the transition portion forming layer was located on the inner layer side, the longer the axial directional length of the transition portion forming layer was. All of the transition portion forming layers s9, s10, s11 and s12 were butt partial layers. All of the transition portion forming layers s9, s10, s11 and s12 were straight layers. The number of plies of each of the transition portion forming layers s9, s10, s11 and s12 increased toward the tip end Tp. The transition portion cover layer s13 was a full length layer and straight layer. A shaft of Example 2 was obtained by the above-described manufacturing processes. The four transition portion forming layers were used to obtain the shaft having four transition portions and three intermediate portions as shown in FIG. 2.

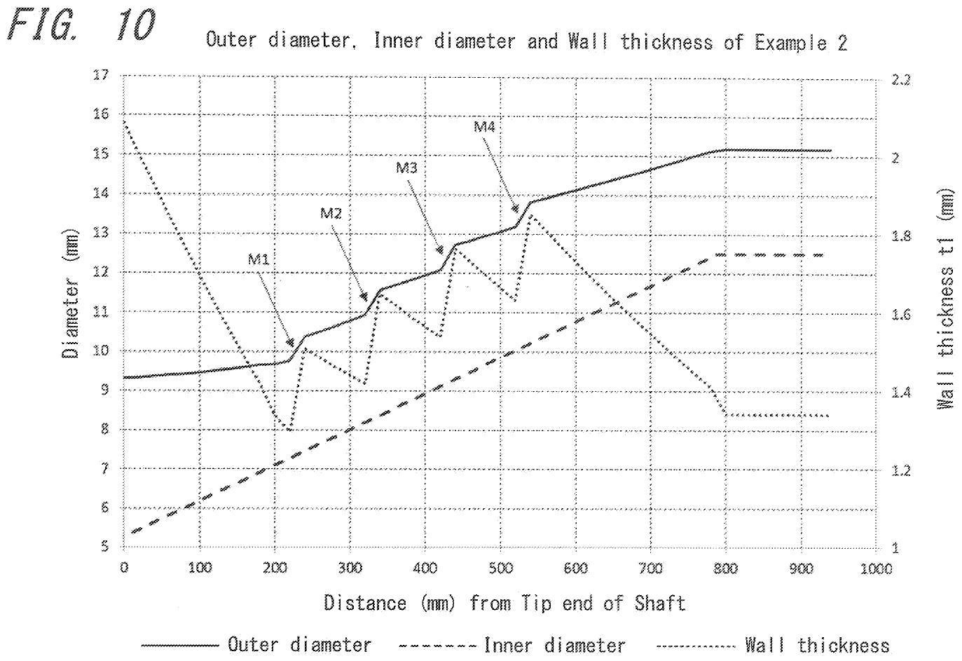

FIG. 10 is a graph showing the outer diameter, inner diameter and shaft wall thickness t1 of the shaft of Example 2. In this graph, the outer diameter and the inner diameter were plotted against the left-hand scale, and the wall thickness t1 was plotted against the right-hand scale. The horizontal axis of this graph represents distance from the tip end Tp. The outer diameter is indicated by a solid line, the inner diameter is indicated by a dashed line, and the wall thickness t1 is indicated by a dotted line. In the graph, the rate of change of the outer diameter becomes sharp at four positions, and these four positions correspond to the transition portions. The first transition portion is shown as M1, the second transition portion is shown as M2, the third transition portion is shown as M3, and the fourth transition portion is shown as M4.

In Example 2, the amount of change of the outer diameter of each transition portion was 0.6 mm. The axial directional length L2 of each transition portion was 20 mm. The axial directional length L12 of each intermediate portion was 80 mm. All of the transition portions were disposed in a region that extends from the first position P1 to the second position P2 (see FIG. 2).

As shown by the dashed line, the inner surface taper ratio was constant in the transition portion locational region R1 (see FIG. 2). This inner surface was shaped by a mandrel.

As shown by the solid line and the dashed line, all of the transition portions each had an outer surface taper and an inner surface taper. All of the intermediate portions also each had an outer surface taper and an inner surface taper. These shapes were successfully adjusted by adjusting the shape of the mandrel and the shape of each transition portion forming sheet.

Example 2 exhibited the same advantageous effects as in Example 1. In Example 1 (FIG. 7), the transition portion forming layers s8 to s11 each had a constant circumferential directional width W2. Meanwhile, in Example 2 (FIG. 9), the transition portion forming layers s9 to s12 each had a circumferential directional width W2 increasing toward the tip end Tp. In both Example 1 and Example 2, the number of plies each transition portion forming layer increased toward the tip end Tp. However, the rate of increase of the number of plies in Example 2 was larger than that of Example 1. As described above, each transition portion forming layer had a circumferential directional width W21 at its tip-side end and a circumferential directional width W22 at its butt-side end. In both Example 1 (FIG. 7) and Example 2 (FIG. 9), the circumferential directional width W21 was greater than or equal to the circumferential directional width W22. In Example 2, however, the circumferential directional width W21 was greater than the circumferential directional width W22. Example 2 had a larger circumferential directional width W21, whereby the amount of change of the outer diameter of each transition portion was effectively increased. In both Example 1 and Example 2, the shaft wall thickness t1 of each intermediate portion increased toward the tip end Tp. However, the rate of change of this wall thickness t1 was further increased in Example 2.

In Example 1 (FIG. 7), the tip-side edge Hi of each of the transition portion forming layers s8 to s11 had the axial directional width W1. That is, the axial directional width W1 was greater than 0 mm. On the other hand, in Example 2 (FIG. 9), the tip-side edge Hi of each of the transition portion forming layers s9 to s12 did not have the axial directional width W1. That is, the axial directional width W1 was 0 mm. For this reason, the axial directional length L2 (see FIG. 1) of each transition portion was substantially 0 mm. However, in Example 2, each transition portion had a taper due to the presence of the transition portion cover layer s13. That is, each transition portion had an axial directional length L2 of less than 1 mm. The viewability of the transition portions was high in Example 2.

In Example 1 and Example 2, the transition portion forming layers were straight layers. In this configuration, EI can be largely changed. Accordingly, for example, the configuration can make the butt portion (grip area) to which the largest force is applied during a swing harder, whereby a shaft endurable against the force applied on the gripped portion can be designed. Alternatively, when the transition portion forming layers are the bias layers, GJ can be greatly changed. Accordingly, for example, this configuration can make the grip area less likely to twist, which can provide feeling for easy operation. At the same time, this configuration can make GJ on the head side lower, whereby an action of golfer's hands trying to close or open the club face is less likely to be conveyed to the head. Accordingly, this configuration can achieve a shaft that can provide feeling for easy operation and that can provide a straight swing path of the head while suppressing the open or close action of the head.

In Example 1 and Example 2, the transition portion forming layers were the straight layers. By laminating the transition portion forming layers, the butt portion became harder, which can provide solid feel required by advanced golfers. By using the transition portion forming layers shorter than a full length layer, the butt portion can be hardened with a small amount of prepreg sheets. This can also locate the center of gravity of the shaft at a position closer to the butt end. In Example 1 and Example 2, the tip partial layers were bias layers, thereby effectively suppressing shaft torque. Note that the shaft torque means a twist angle formed when a certain torque is applied to a shaft. The smaller the shaft torque is, the higher the torsional rigidity of the entire shaft is. Such a property is suitable for an iron shaft used by advanced golfers, for example.

In the above embodiments, each transition portion is formed by the edge of a transition portion forming layer. In the present disclosure, however, the transition portion is not limited to this structure. For example, the transition portions may be formed by cutting process (polishing process).

There is no limitation on the shaft length Ls. The shaft length Ls can be greater than or equal to 889 mm and less than or equal to 1194 mm. The shaft of the present disclosure can be used for all kinds of clubs, such as wood-type clubs, hybrid-type clubs, iron-type clubs, and putter-type clubs. That is, the shaft of the present disclosure may be a wood-type shaft used for a wood-type club, a hybrid-type shaft used for a hybrid-type club, an iron-type shaft used for an iron-type club, or a putter-type shaft used for a putter-type club. When the shaft of the present disclosure is a hybrid-type shaft, the shaft length Ls can be greater than or equal to 951 mm and less than or equal to 1017 mm. When the shaft of the present disclosure is an iron-type shaft, the shaft length Ls can be greater than or equal to 889 mm and less than or equal to 959 mm.

There is no limitation on the weight of the shaft. The weight of the shaft can be greater than or equal to 30 g and less than or equal to 130 g. From the viewpoint of strength, the shaft weight is preferably greater than or equal to 35 g, more preferably greater than or equal to 40 g, and still more preferably greater than or equal to 45 g. From the viewpoint of ease of swing, the shaft weight is preferably less than or equal to 120 g, more preferably less than or equal to 110 g, and still more preferably less than or equal to 100 g. When the plurality of transition portion forming layers are provided, considering the weight for these layers, the shaft weight is preferably greater than or equal to 50 g, more preferably greater than or equal to 55 g, still more preferably greater than or equal to 60 g, and yet more preferably greater than or equal to 65 g. When the shaft is an iron-type shaft, from the viewpoint of increasing the transition portion forming layers, the shaft weight can be greater than or equal to 70 g, further can be greater than or equal to 75 g, and still further can be greater than or equal to 80 g. When the shaft is an iron-type shaft, from the viewpoint of ease of swing and stability, a relatively heavier shaft tends to be required. The upper limit of the weight of the iron-type shaft can be less than or equal to 120 g, further can be less than or equal to 115 g, and still further can be less than or equal to 110 g. When the shaft is a hybrid-type shaft, intermediate properties between the wood-type shaft and the iron-type shaft can be required. Considering also the presence of the transition portion forming layers, the lower limit of the weight of the hybrid-type shaft can be greater than or equal to 65 g, further can be greater than or equal to 70 g, and still further can be greater than or equal to 75 g, and the upper limit of the weight of the hybrid-type shaft can be less than or equal to 105 g, further can be less than or equal to 100 g, and still further can be less than or equal to 95 g.

The following clauses are a part of invention included in the present disclosure.

### Clause 1

A golf club shaft including a plurality of fiber reinforced resin layers, a tip end, and a butt end, wherein
the golf club shaft also includes:
   a plurality of extending portions each having an axial directional length of greater than 25 mm, and
   a plurality of transition portions each having an axial directional length of less than or equal to 25 mm and each having an outer diameter changing by 0.3 mm or more,
each of the transition portions connects two of the extending portions, and
the extending portions include at least one intermediate portion that connects two of the transition portions.

### Clause 2

The golf club shaft according to clause 1, wherein
the intermediate portion has an outer surface taper ratio smaller than outer surface taper ratios of all of the transition portions.

### Clause 3

The golf club shaft according to clause 1 or 2, wherein
the number of the transition portions is greater than or equal to 3,
the at least one intermediate portion comprises a plurality of intermediate portions, and
the number of the intermediate portions is greater than or equal to 2.

### Clause 4

The golf club shaft according to any one of clauses 1 to 3, wherein
each of the transition portions has an axial directional length of less than or equal to 20 mm, and has an outer diameter changing by 0.3 mm or more.

### Clause 5

The golf club shaft according to any one of clauses 1 to 3, wherein
each of the transition portions has an axial directional length of less than or equal to 15 mm, and has an outer diameter changing by 0.3 mm or more.

### Clause 6

The golf club shaft according to any one of clauses 1 to 5, wherein
each of the transition portions has a shaft wall thickness decreasing toward the tip end.

### Clause 7

The golf club shaft according to any one of clauses 1 to 6, wherein
the at least one intermediate portion has a shaft wall thickness increasing toward the tip end.

### Clause 8

The golf club shaft according to any one of clauses 1 to 7, wherein
the fiber reinforced resin layers include at least one full length layer disposed over an entire length of the golf club shaft in an axial direction, and a plurality of partial layers each being disposed on a part of the golf club shaft in the axial direction,
the partial layers include a plurality of transition portion forming layers,
each of the transition portion forming layers extends from a butt side of the golf club shaft to an intermediate position of the golf club shaft, and tip-side edges of transition portion forming layers constitute the respective transition portions.

### Clause 9

The golf club shaft according to clause 8, wherein
as to the transition portion forming layers, the more the transition portion to be formed by the transition portion forming layer is located on a tip side, the more the transition portion forming layer is disposed on an inner layer side.

### Clause 10

The golf club shaft according to clause 8 or 9, wherein
when a circumferential directional width of each of the transition portion forming layers at a tip-side end is denoted by W21, and a circumferential directional width of each of the transition portion forming layers at a butt-side end is denoted by W22, then
W21 is greater than or equal to W22.

### Clause 11

The golf club shaft according to any one of clauses 8 to 10, wherein
the full length layer includes a transition portion cover layer disposed on an outer layer side with respect to a transition portion forming layer which is a first layer counted from the outer layer side among the transition portion forming layers,
the number of plies of the transition portion cover layer is only one, and
the transition portion cover layer has a basis weight of less than or equal to 170 g/m².

### LIST OF REFERENCE SYMBOLS

100, 200, 300, 400, 500 Shaft
102 Outer surface of the shaft
104 Inner surface of the shaft
110, 210, 310, 410, 510 Extending portion
110a, 210a, 310a, 410a, 510a Tip extending portion
110b, 210b, 310b, 410b, 510b Butt extending portion
110c, 210c, 310c, 410c, 510c Intermediate portion
112, 212, 312, 412, 512 Transition portion
M1 First transition portion
M2 Second transition portion
M3 Third transition portion
M4 Fourth transition portion
M5 Fifth transition portion
J1 First intermediate portion
J2 Second intermediate portion
J3 Third intermediate portion
J4 Fourth intermediate portion
Tp Tip end
Bt Butt end
Ls Shaft length
L1 Axial directional length of the extending portion
L10 Axial directional length of the tip extending portion
L11 Axial directional length of the butt extending portion
L12 Axial directional length of the intermediate portion
L2 Axial directional length of the transition portion
t1 Wall thickness of the shaft (Shaft wall thickness)
Z Center line of the shaft

The above descriptions are merely illustrative and various modifications can be made without departing from the principles of the present disclosure.

The terminology used in the description of the various described embodiments herein is for the purpose of describing particular embodiments only and is not intended to be limiting. The use of the terms “a”, “an”, “the”, and similar referents in the context of throughout this disclosure (especially in the context of the following claims) are to be construed to cover both the singular and the plural, unless otherwise indicated herein or clearly contradicted by context. As used throughout this disclosure, the word “may” is used in a permissive sense (i.e., meaning “having the potential to”), rather than the mandatory sense (i.e., meaning “must”). Similarly, as used throughout this disclosure, the terms “comprising,” “having,” “including,” and “containing” are to be construed as open-ended terms (i.e., meaning “including, but not limited to,”) unless otherwise noted.

What is claimed is:

1. A golf club shaft comprising a plurality of fiber reinforced resin layers, a tip end, and a butt end, wherein
the golf club shaft also includes:
a plurality of extending portions each having an axial directional length of greater than 25 mm, and
a plurality of transition portions each having an axial directional length of less than or equal to 25 mm and each having an outer diameter changing by 0.3 mm or more,
each of the transition portions connects two of the extending portions, and
the extending portions include at least one intermediate portion that connects two of the transition portions.

2. The golf club shaft according to claim 1, wherein
the intermediate portion has an outer surface taper ratio smaller than outer surface taper ratios of all of the transition portions.

3. The golf club shaft according to claim 1, wherein
the number of the transition portions is greater than or equal to 3,
the at least one intermediate portion comprises a plurality of intermediate portions, and
the number of the intermediate portions is greater than or equal to 2.

4. The golf club shaft according to claim 1, wherein
each of the transition portions has an axial directional length of less than or equal to 20 mm, and has an outer diameter changing by 0.3 mm or more.

5. The golf club shaft according to claim 1, wherein
each of the transition portions has an axial directional length of less than or equal to 15 mm, and has an outer diameter changing by 0.3 mm or more.

6. The golf club shaft according to claim 1, wherein
each of the transition portions has a shaft wall thickness decreasing toward the tip end.

7. The golf club shaft according to claim 1, wherein
the at least one intermediate portion has a shaft wall thickness increasing toward the tip end.

8. The golf club shaft according to claim 1, wherein
the fiber reinforced resin layers include at least one full length layer disposed over an entire length of the golf club shaft in an axial direction, and a plurality of partial layers each being disposed on a part of the golf club shaft in the axial direction,
the partial layers include a plurality of transition portion forming layers,
each of the transition portion forming layers extends from a butt side of the golf club shaft to an intermediate position of the golf club shaft, and
tip-side edges of the transition portion forming layers constitute the respective transition portions.

9. The golf club shaft according to claim 8, wherein
as to the transition portion forming layers, the more the transition portion to be formed by the transition portion forming layer is located on a tip side, the more the transition portion forming layer is disposed on an inner layer side.

10. The golf club shaft according to claim 8, wherein
in each of the transition portion forming layers, when a circumferential directional width at a tip-side end is denoted by W21, and a circumferential directional width at a butt-side end is denoted by W22, then
W21 is greater than or equal to W22.

11. The golf club shaft according to claim 8, wherein
the full length layer includes a transition portion cover layer disposed on an outer layer side with respect to a transition portion forming layer which is a first layer counted from the outer layer side among the transition portion forming layers,
the number of plies of the transition portion cover layer is only one, and
the transition portion cover layer has a basis weight of less than or equal to 170 g/m².

12. A golf club shaft comprising a plurality of fiber reinforced resin layers, a tip end, and a butt end, wherein
the golf club shaft also includes:
a plurality of extending portions each having an axial directional length of greater than 25 mm, and
a plurality of transition portions each having an axial directional length of less than or equal to 25 mm and each having an outer diameter changing by 0.3 mm or more,
each of the transition portions connects two of the extending portions,
the extending portions include at least one intermediate portion that connects two of the transition portions, and
the transition portions each have an inner surface taper ratio of less than 0.3 mm/25 mm.

13. The golf club shaft according to claim 12, wherein
the intermediate portion has an outer surface taper ratio smaller than outer surface taper ratios of all of the transition portions.

14. The golf club shaft according to claim 12, wherein
the number of the transition portions is greater than or equal to 3,
the at least one intermediate portion comprises a plurality of intermediate portions, and
the number of the intermediate portions is greater than or equal to 2.

15. The golf club shaft according to claim 12, wherein
each of the transition portions has a shaft wall thickness decreasing toward the tip end.

16. The golf club shaft according to claim 12, wherein
the at least one intermediate portion has a shaft wall thickness increasing toward the tip end.

17. The golf club shaft according to claim 12, wherein
an inner surface taper ratio over an entire length of the golf club shaft is smaller than 0.3 mm/25 mm.

18. The golf club shaft according to claim 12, wherein
the fiber reinforced resin layers include at least one full length layer disposed over an entire length of the golf club shaft in an axial direction, and a plurality of partial layers each being disposed on a part of the golf club shaft in the axial direction,
the partial layers include a plurality of transition portion forming layers,
each of the transition portion forming layers extends from a butt side of the golf club shaft to an intermediate position of the golf club shaft, and
tip-side edges of the transition portion forming layers constitute the respective transition portions.

19. The golf club shaft according to claim 18, wherein
as to the transition portion forming layers, the more the transition portion to be formed by the transition portion forming layer is located on a tip side, the more the transition portion forming layer is disposed on an inner layer side.

20. The golf club shaft according to claim 18, wherein
in each of the transition portion forming layers, when a circumferential directional width at a tip-side end is denoted by W21, and a circumferential directional width at a butt-side end is denoted by W22, then
W21 is greater than or equal to W22.
